(19) United States
(12) Patent Application Publication
(10) Pub. No.: US 2007/0097818 A1
(43) Pub. Date: May 3, 2007

(54) PLAYBACK DEVICE AND METHOD THEREFOR

(75) Inventors: Fumihiko Madate, Yokohama-Shi (JP); Atsushi Takeda, Yokohama-Shi (JP); Yukihiko Hashimoto, Kawasaki-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/553,696

(22) Filed: Oct. 27, 2006

(30) Foreign Application Priority Data
Oct. 28, 2005 (JP) 2005-314130

(51) Int. Cl. G11B 19/00

(52) U.S. Cl. 369/47.48; 369/47.4

(57) ABSTRACT

According to this invention, there is provided a playback device including a control unit which causes a rotational speed control unit to control the rotational speed of a drive unit on the basis of a first reference signal such that the rotational speed of the drive unit becomes almost equal to a rotational speed with which second data can be played back from a second recording area, by causing a playback unit to move to a first recording area of a disc-like recording medium and causing a selection unit to select the first reference signal, and then causes the rotational speed control unit to control the rotational speed of the drive unit on the basis of a second reference signal by causing the playback unit to move to the second recording area and causing the selection unit to select the second reference signal.

### CROSS REFERENCE TO RELATED APPLICATIONS

This application is based upon and claims benefit of priority under 35 USC 119 from the Japanese Patent Application No. 2005-314130, filed on Oct. 28, 2005, the entire contents of which are incorporated herein by reference.

### BACKGROUND OF THE INVENTION

The present invention relates to a playback device and a control method therefor.

An optical disc device rotates an optical disc using a spindle motor. As methods for controlling the rotational speed of a spindle motor, there are proposed various methods. A method for controlling the rotational speed of a spindle motor will be specifically explained.

Generally, an FG signal generator which generates an FG (Frequency Generator) signal by outputting a pulse with a predetermined shape each time a spindle motor rotates by a fixed angle is attached to the spindle motor.

An optical disc device can calculate the rotational speed of a spindle motor by detecting pulses of an FG signal output from an FG signal generator and control the rotational speed of the spindle motor on the basis of the calculation result.

Pits for recording data such as video data are formed in an optical disc. Sync patterns as synchronization signals are also recorded in the pits. An optical disc device can also control the rotational speed of a spindle motor on the basis of sync patterns detected from data obtained by irradiating pits with laser light.

An optical disc also has wobbles, each composed of a groove formed to wobble in fixed cycles. Each wobble mainly serves as a guide groove. An optical disc device can also control the rotational speed of a spindle motor on the basis of wobble signals obtained by irradiating wobbles with laser light.

A BCA (burst cutting area) is formed on the inner peripheral side of an optical disc based on a current DVD (Digital Versatile Disc) standard or the HD DVD standard, which is considered to be a leading one of next-generation DVD standards. A barcode-like pattern is formed in the BCA to radiate in the radial direction of the optical disc, depending on data to be recorded. For example, unique identification information assigned to the optical disc and copy protection information are recorded in the BCA.

As described above, no pits are formed in a BCA of an optical disc based on a DVD standard or the HD DVD standard, unlike a data area. Accordingly, in the BCA, no sync patterns as described above are recorded, and no wobbles are formed.

For this reason, an optical disc device with such an optical disc controls the rotational speed of a spindle motor on the basis of an FG signal output from an FG signal generator when reading out data from a BCA of the optical disc.

Assume that no FG signal generator is provided for the spindle motor. In this case, when the optical disc device reads out data from the BCA, it cannot control the rotational speed of the spindle motor. This makes it impossible to stably rotate an optical disc at a fixed rotational speed and reduces data readout accuracy. Accordingly, an FG signal generator needs to be provided for a spindle motor, and the size of an optical disc device increases correspondingly.

The following is the name of a document pertaining to an optical disc device:

Japanese Patent Laid-Open No. 11-328857

### SUMMARY OF THE INVENTION

According to one aspect of the present invention, there is provided a playback device including
a drive unit which rotates a disc-like recording medium having a first recording area with first data recorded and a second recording area with second data recorded different from the first data and needing to be rotated at a predetermined rotational speed to play back the second data from the second recording area,
a playback unit which plays back data from the disc-like recording medium,
a first detection unit which detects a first reference signal serving as a reference for calculating the rotational speed of the disc-like recording medium from data played back from the first recording area,
a second detection unit which detects a second reference signal serving as a reference for calculating the rotational speed of the disc-like recording medium from data played back from the second recording area,
a selection unit which selects and outputs one of the first and second reference signals output from the first and second detection units,
a rotational speed control unit which controls a rotational speed of the drive unit on the basis of the one of the first and second reference signals, and
a control unit which causes the rotational speed control unit to control the rotational speed of the drive unit on the basis of the first reference signal such that the rotational speed of the drive unit becomes almost equal to a rotational speed with which the second data can be played back from the second recording area, by causing the playback unit to move to the first recording area of the disc-like recording medium and causing the selection unit to select the first reference signal, and then causes the rotational speed control unit to control the rotational speed of the drive unit on the basis of the second reference signal by causing the playback unit to move to the second recording area and causing the selection unit to select the second reference signal.

According to one aspect of the present invention, there is provided a playback device including
a drive unit which rotates a disc-like recording medium having a first recording area with first data recorded and a second recording area with second data recorded different from the first data and needing to be rotated at a predetermined rotational speed to play back the second data from the second recording area,
a playback unit which plays back data from the disc-like recording medium,
a detection unit which detects a reference signal serving as a reference for calculating the rotational speed of the disc-like recording medium from data played back from the second recording area,
a rotational speed control unit which controls a rotational speed of the drive unit on the basis of the reference signal, and
a control unit which causes the playback unit to move to the second recording area of the disc-like recording medium, stepwise changes the rotational speed of the drive unit by controlling operation of the rotation control unit, and, if the reference signal is supplied from the detection unit, controls the rotational speed of the drive unit on the basis of the reference signal.

### BRIEF DESCRIPTION OF THE DRAWINGS

FIG. 1 is a block diagram showing the configuration of an optical disc device according to an embodiment of the present invention;

FIG. 2 is an explanatory view showing the configuration of an optical disc in the optical disc device;

FIG. 3 is a flowchart showing a rotational speed control procedure according to the embodiment of the present invention; and

FIG. 4 is a flowchart showing a rotational speed control procedure according to another embodiment.

### DETAILED DESCRIPTION OF THE INVENTION

An embodiment of the present invention will be explained with reference to the drawings.

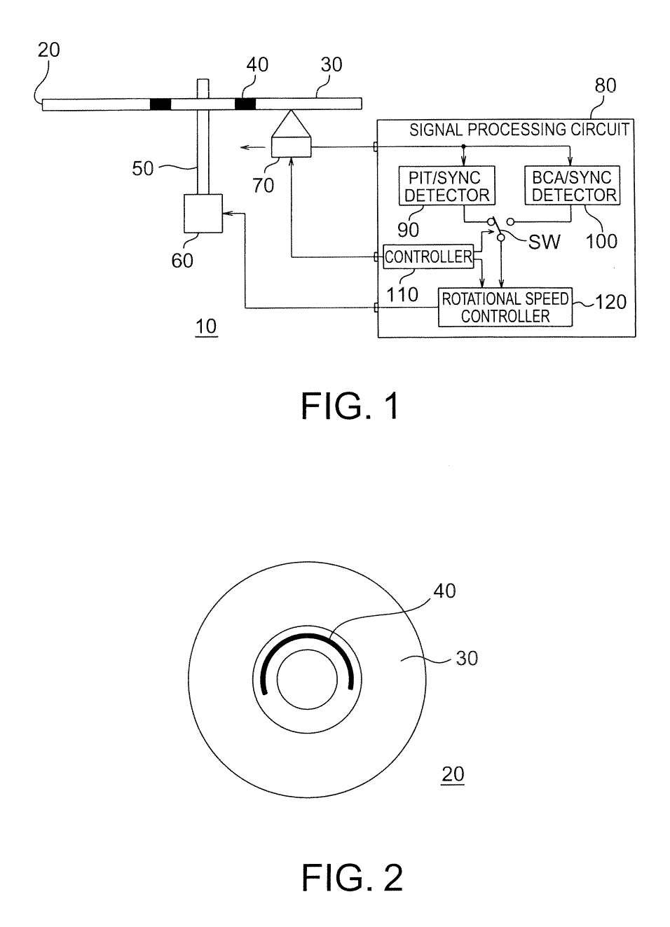

FIG. 1 shows the configuration of an optical disc device 10 according to the embodiment of the present invention, and FIG. 2 shows the configuration of an optical disc 20 used in the optical disc device 10. As shown in FIG. 2, an optical disc based on, e.g., the HD DVD standard is used as the optical disc 20. A data area 30 is formed on the outer peripheral side of the optical disc 20, and a BCA 40 is formed on the inner peripheral side.

Pits (not shown) for recording data such as video data are formed in the data area 30. Sync patterns as synchronization signals are also recorded in the pits. Grooves, i.e., wobbles (not shown) are also formed in the data area 30 to wobble in fixed cycles. Each wobble mainly serves as a guide groove.

A barcode-like pattern (not shown) is formed in the BCA 40 to radiate in the radial direction of the optical disc 20. For example, unique identification information assigned to the optical disc 20 and copy protection information are recorded in the BCA 40. Note that the optical disc device 10 is based on the HD DVD standard and thus configured to play back data recorded in the BCA 40 without fail at the time of playback. This configuration makes it possible to, e.g., prevent unauthorized copying.

At the time of playback, the optical disc 20 is attached to a rotating shaft 50, and the optical disc device 10 rotates the optical disc 20 together with the rotating shaft 50, using a spindle motor 60. At this time, the optical disc device 10 moves an optical pickup head 70 to a desired position and irradiates, e.g., pits with laser light output from the optical pickup head 70. The optical disc device 10 receives light reflected from the pits using the optical pickup head 70 and performs predetermined signal processing for obtained electrical signals (RF signals), thereby generating video signals.

At this time, a signal processing circuit 80 performs the predetermined signal processing for the electrical signals output from the optical pickup head 70. The rotational speed of the spindle motor 60 is controlled on the basis of the processing result.

As described above, the optical disc device 10 is based on the HD DVD standard and thus configured to play back data recorded in the BCA 40 without fail at the time of playback, in order to, e.g., prevent unauthorized copying.

However, the HD DVD standard prescribes a rotational speed for the spindle motor 60 with which data can be played back from the BCA 40. Even if the optical disc 20 is rotated at a rotational speed different from the prescribed rotational speed, data cannot be played back from the BCA 40. Accordingly, the optical disc device 10 needs to rotate the optical disc 20 at the predetermined rotational speed prescribed by the HD DVD standard to play back data from the BCA 40, unlike the case of the data area 30.

In this embodiment, when the optical disc device 10 plays back data from the BCA 40, it first moves the optical pickup head 70 to the data area 30. The optical disc device 10 controls the rotational speed of the spindle motor 60 such that the rotational speed of the spindle motor 60 becomes almost equal to the rotational speed which is prescribed by the HD DVD standard and with which data can be played back from the BCA 40, by playing back data from the data area 30.

After that, the optical disc device 10 moves the optical pickup head 70 to the BCA 40. At this time, the rotational speed of the spindle motor 60 may change slightly. In this case, the optical disc device 10 plays back the data from the BCA 40 and detects, from the played-back data, a sync pattern (a reference signal serving as a reference for calculating the rotational speed of the spindle motor 60) which is a unique bit pattern. With this operation, the optical disc device 10 controls the rotational speed of the spindle motor 60 such that the rotational speed of the spindle motor 60 becomes the rotational speed prescribed by the HD DVD standard.

As described above, the optical disc can be stably rotated at the predetermined rotational speed by controlling the rotational speed of the spindle motor 60 with high accuracy while playing back the data from the BCA 40. Accordingly, data readout accuracy can be increased.

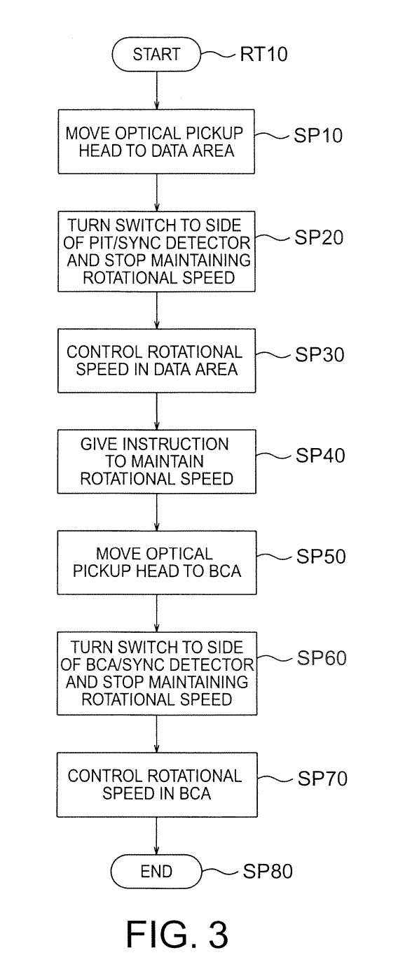

FIG. 3 shows a rotational speed control procedure RT10 according to this embodiment when playing back data from the BCA 40. In FIG. 3, at the time of playback, the rotational speed control procedure RT10 starts. A controller 110 of the signal processing circuit 80 rotates the spindle motor 60 at the predetermined rotational speed by controlling the operation of a rotational speed controller 120 and maintains the rotational speed. After that, in step SP10, the controller 110 moves the optical pickup head 70 to the data area 30.

In this case, the optical disc device 10 irradiates, e.g., pits with laser light emitted from the optical pickup head 70 and receives light reflected from the pits using the optical pickup head 70. The optical disc device 10 supplies obtained electrical signals to the signal processing circuit 80. The signal processing circuit 80 inputs the electrical signals to a pit/sync detector 90 and a BCA/sync detector 100.

In step SP20, the controller 110 turns a switch SW to the side of the pit/sync detector 90 and causes the rotational speed controller 120 to stop maintaining the rotational speed of the spindle motor 60. In this case, when the pit/sync detector 90 detects sync patterns recorded in the pits of the data area 30 from electrical signals output from the optical pickup head 70, it notifies the rotational speed controller 120 that the sync patterns are detected.

In step SP30, the rotational speed controller 120 calculates the rotational speed of the spindle motor 60 on the basis of time intervals at which the sync patterns are detected and controls the rotational speed of the spindle motor 60 based on the calculation result. With this operation, the rotational speed of the spindle motor 60 is controlled to be almost equal to the rotational speed which is prescribed by the HD DVD standard and with which data can be played back from the BCA 40.

In step SP40, the controller 110 controls the operation of the rotational speed controller 120, thereby maintaining the rotational speed of the spindle motor 60. After that, the flow shifts to step SP50, and the controller 110 moves the optical pickup head 70 to the BCA 40.

At this time, the rotational speed controller 120 tries to maintain the rotational speed of the spindle motor 60. However, since the rotational speed of the spindle motor 60 is not controlled by calculating the actual rotational speed of the spindle motor 60, the rotational speed of the spindle motor 60 may change slightly.

In step SP60, the controller 110 turns the switch SW to the side of the BCA/sync detector 100 and causes the rotational speed controller 120 to stop maintaining the rotational speed of the spindle motor 60. In this case, when the BCA/sync detector 100 detects sync patterns recorded in the BCA 40 from electrical signals output from the optical pickup head 70, it notifies the rotational speed controller 120 that the sync patterns are detected.

In step SP70, the rotational speed controller 120 calculates the rotational speed of the spindle motor 60 on the basis of time intervals at which the sync patterns are detected and controls the rotational speed of the spindle motor 60 based on the calculation result. With this operation, the rotational speed of the spindle motor 60 is controlled with high accuracy to be almost equal to the rotational speed which is prescribed by the HD DVD standard and with which data can be played back from the BCA 40.

As described above, according to this embodiment, the optical disc can be stably rotated at the fixed rotational speed when playing back the data from the BCA 40. Accordingly, the data readout accuracy can be increased.

This embodiment eliminates the need to provide an FG signal generator for the spindle motor 60 and makes it possible to correspondingly simplify the configuration of the optical disc device 10.

This embodiment also eliminates the need to provide an FG signal detector for detecting an FG signal in the signal processing circuit 80 and makes it possible to correspondingly simplify the configuration of the signal processing circuit 80. This eliminates the need to provide an input terminal for inputting, to the signal processing circuit 80, an FG signal output from an FG signal detector.

Note that the above-described embodiment is merely an example and not intended to limit the present invention. For example, it is also possible to control the rotational speed of the spindle motor 60 by detecting anything other than a sync pattern as a reference signal for calculating the rotational speed of the spindle motor 60 when playing back the data from the BCA 40. Examples of the reference signal include a resync pattern which is another type of synchronization pattern, a preamble indicating the start of data, and a postamble indicating the end of data.

It is also possible to control the rotational speed of the spindle motor 60 by detecting not sync patterns obtained from pits but wobble signals obtained from wobbles when playing back data from the data area 30.

As the optical disc 20, an optical disc based on a DVD standard may be used instead of an optical disc based on the HD DVD standard.

When the controller 110 plays back data from the BCA 40, it may move the optical pickup head 70 to the BCA 40 without playing back data from the data area 30. After that, the controller 110 may try to detect sync patterns recorded in the BCA 40 while changing the rotational speed of the spindle motor 60. The rotational speed of the spindle motor 60 may be controlled only if the detection of the sync patterns is successful. In this case, the controller 110 turns the switch SW to the side of the BCA/sync detector 100 in advance.

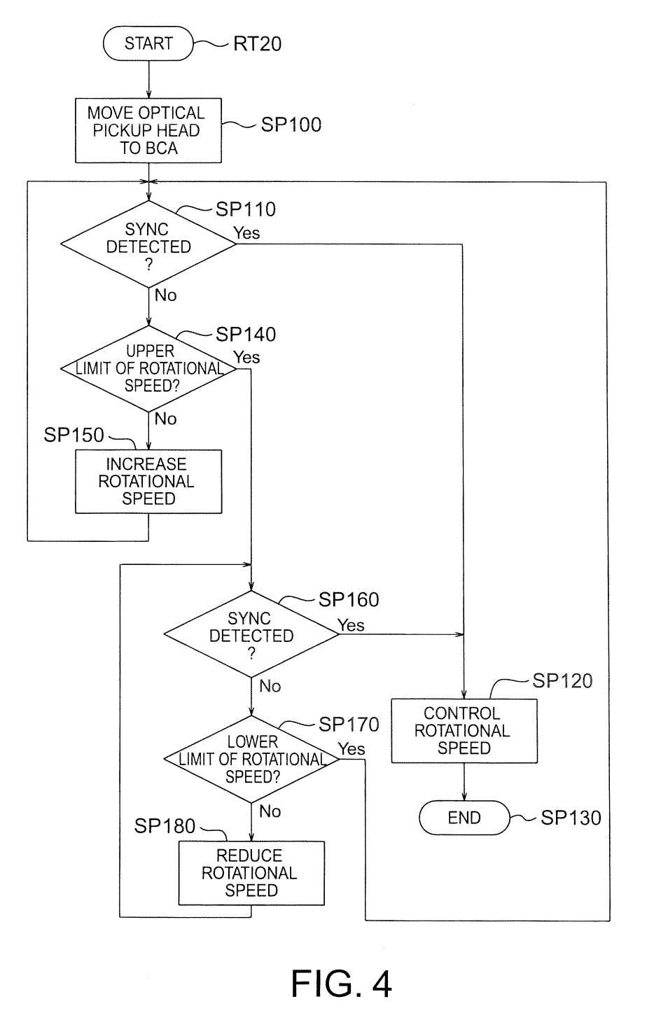

FIG. 4 shows a rotational speed control procedure RT20 according to another embodiment when playing back data from a BCA 40 without playing back data from a data area 30. In FIG. 4, at the time of playback, the rotational speed control procedure RT20 starts. In step SP100, a controller 110 of a signal processing circuit 80 rotates a spindle motor 60 at a predetermined rotational speed by controlling the operation of a rotational speed controller 120. At the same time, the controller 110 moves an optical pickup head 70 to the BCA 40.

In step SP110, the rotational speed controller 120 determines whether it is notified by a BCA/sync detector 100 that sync patterns are detected. If an affirmative result is obtained in step SP110, the flow shifts to step SP120, and the rotational speed controller 120 controls the rotational speed of the spindle motor 60. After that, the flow shifts to step SP130, and the procedure RT20 ends.

On the other hand, if a negative result is obtained in step SP110, the flow shifts to step SP140, and the rotational speed controller 120 determines whether a current rotational speed is equal to a predetermined upper limit. If a negative result is obtained in step SP140, the flow shifts to step SP150. In step SP150, the rotational speed controller 120 increases the rotational speed of the spindle motor 60 by a predetermined value, and the flow returns to step SP110 to repeat the above-described operation. Attempts are made to detect a sync pattern while stepwise increasing the rotational speed of the spindle motor 60.

On the other hand, if an affirmative result is obtained in step SP140, the flow shifts to step SP160. In step SP160, the rotational speed controller 120 determines whether it is notified by the BCA/sync detector 100 that sync patterns are detected. If an affirmative result is obtained in step SP160, the flow shifts to step SP120, and the rotational speed controller 120 controls the rotational speed of the spindle motor 60. After that, the flow shifts to step SP130, and the procedure RT20 ends.

On the other hand, if a negative result is obtained in step SP160, the flow shifts to step SP170. In step SP170, the rotational speed controller 120 determines whether the current rotational speed is equal to a predetermined lower limit. If a negative result is obtained in step SP170, the flow shifts to step SP180. In step SP180, the rotational speed controller 120 reduces the rotational speed of the spindle motor 60 by a predetermined value, and the flow shifts to step SP160 to repeat the above-described operation. Attempts are made to detect a sync pattern while stepwise reducing the rotational speed.

On the other hand, if an affirmative result is obtained in step SP170, the flow returns to step SP110, and the rotational speed controller 120 repeats the above-described operation. Attempts are made again to detect a sync pattern while stepwise increasing the rotational speed of the spindle motor 60.

What is claimed is:

1. A playback device comprising:
a drive unit which rotates a disc-like recording medium having a first recording area with first data recorded and a second recording area with second data recorded different from the first data and needing to be rotated at a predetermined rotational speed to play back the second data from the second recording area;
a playback unit which plays back data from the disc-like recording medium;
a first detection unit which detects a first reference signal serving as a reference for calculating the rotational speed of the disc-like recording medium from data played back from the first recording area;
a second detection unit which detects a second reference signal serving as a reference for calculating the rotational speed of the disc-like recording medium from data played back from the second recording area;
a selection unit which selects and outputs one of the first and second reference signals output from the first and second detection units;
a rotational speed control unit which controls a rotational speed of the drive unit on the basis of the one of the first and second reference signals; and
a control unit which causes the rotational speed control unit to control the rotational speed of the drive unit on the basis of the first reference signal such that the rotational speed of the drive unit becomes almost equal to a rotational speed with which the second data can be played back from the second recording area, by causing the playback unit to move to the first recording area of the disc-like recording medium and causing the selection unit to select the first reference signal, and then causes the rotational speed control unit to control the rotational speed of the drive unit on the basis of the second reference signal by causing the playback unit to move to the second recording area and causing the selection unit to select the second reference signal.

2. The playback device according to claim 1, wherein the first reference signal is one of a sync pattern obtained from a pit and a wobble signal obtained from a wobble.

3. The playback device according to claim 1, wherein the second reference signal is one of a sync pattern and a resync pattern.

4. The playback device according to claim 1, wherein the first recording area is a data area formed on an outer peripheral side of the disc-like recording medium.

5. The playback device according to claim 1, wherein the second recording area is a burst cutting area formed on an inner peripheral side of the disc-like recording medium.

6. The playback device according to claim 1, wherein the drive unit is a spindle motor which rotates the disc-like recording medium attached to a rotating shaft together with the rotating shaft.

7. The playback device according to claim 1, wherein the disc-like recording medium is an optical disc which has a burst cutting area formed on an inner peripheral side.

8. The playback device according to claim 1, wherein the playback unit is composed of an optical pickup head and plays back the data by irradiating a pit with laser light output from the optical pickup head, receiving light reflected from the pit, and obtaining an electrical signal.

9. A playback device comprising:
a drive unit which rotates a disc-like recording medium having a first recording area with first data recorded and a second recording area with second data recorded different from the first data and needing to be rotated at a predetermined rotational speed to play back the second data from the second recording area;
a playback unit which plays back data from the disc-like recording medium;
a detection unit which detects a reference signal serving as a reference for calculating the rotational speed of the disc-like recording medium from data played back from the second recording area;
a rotational speed control unit which controls a rotational speed of the drive unit on the basis of the reference signal; and
a control unit which causes the playback unit to move to the second recording area of the disc-like recording medium, changes the rotational speed of the drive unit by controlling operation of the rotation control unit, and, if the reference signal is supplied from the detection unit, controls the rotational speed of the drive unit on the basis of the reference signal.

10. The playback device according to claim 9, wherein the reference signal is one of a sync pattern and a resync pattern.

11. The playback device according to claim 9, wherein the control unit changes the rotational speed of the drive unit by one of stepwise increasing the rotational speed of the drive unit and stepwise decreasing the rotational speed of the drive unit.

12. A playback method comprising, when a playback device having a drive unit which rotates a disc-like recording medium having a first recording area with first data recorded and a second recording area with second data recorded different from the first data and needing to be rotated at a predetermined rotational speed to play back the second data from the second recording area, a playback unit which plays back data from the disc-like recording medium, a first detection unit which detects a first reference signal serving as a reference for calculating the rotational speed of the disc-like recording medium from data played back from the first recording area, a second detection unit which detects a second reference signal serving as a reference for calculating the rotational speed of the disc-like recording medium from data played back from the second recording area, a selection unit which selects and outputs one of the first and second reference signals output from the first and second detection units, and a rotational speed control unit which controls a rotational speed of the drive unit on the basis of the one of the first and second reference signals plays back the data:
causing the rotational speed control unit to control the rotational speed of the drive unit on the basis of the first reference signal such that the rotational speed of the drive unit becomes almost equal to a rotational speed with which the second data can be played back from the second recording area, by causing the playback unit to move to the first recording area of the disc-like recording medium and causing the selection unit to select the first reference signal; and
causing the rotational speed control unit to control the rotational speed of the drive unit on the basis of the second reference signal by causing the playback unit to move to the second recording area and causing the selection unit to select the second reference signal.

13. The playback method according to claim 12, wherein the first reference signal is one of a sync pattern obtained from a pit and a wobble signal obtained from a wobble.

14. The playback method according to claim 12, wherein the second reference signal is one of a sync pattern and a resync pattern.

15. The playback method according to claim 12, wherein the first recording area is a data area formed on an outer peripheral side of the disc-like recording medium.

16. The playback method according to claim 12, wherein the second recording area is a burst cutting area formed on an inner peripheral side of the disc-like recording medium.

17. The playback method according to claim 12, wherein the drive unit is a spindle motor which rotates the disc-like recording medium attached to a rotating shaft together with the rotating shaft.

18. The playback method according to claim 12, wherein the disc-like recording medium is an optical disc which has a burst cutting area formed on an inner peripheral side.

19. The playback method according to claim 12, wherein the playback unit is composed of an optical pickup head and plays back the data by irradiating a pit with laser light output from the optical pickup head, receiving light reflected from the pit, and obtaining an electrical signal.
